(19) United States
(12) Patent Application Publication
(10) Pub. No.: US 2023/0137905 A1
(43) Pub. Date: May 4, 2023

(54) SOURCE-FREE ACTIVE ADAPTATION TO DISTRIBUTIONAL SHIFTS FOR MACHINE LEARNING

(71) Applicant: Intel Corporation, Santa Clara, CA (US)

(72) Inventors: Amrutha Machireddy, Bengaluru (IN); Ranganath Krishnan, Hillsboro, OR (US); Nilesh Ahuja, Cupertino, CA (US); Omesh Tickoo, Portland, OR (US)

(21) Appl. No.: 18/089,513

(22) Filed: Dec. 27, 2022

(51) Int. Cl. G06N 3/091

(52) U.S. Cl. CPC G06N 3/091

(57) ABSTRACT

Disclosed is an example solution to perform source-free active adaptation to distributional shifts for machine learning. The example solution includes: interface circuitry; programmable circuitry; and instructions to cause the programmable circuitry to: perform a first training of a neural network on a baseline data set associated with a first data distribution; compare data of a shifted data set to a threshold uncertainty value, wherein the threshold uncertainty value is associated with a distributional shift between the baseline data set and the shifted data set; generate a shifted data subset including items of the shifted dataset that satisfy the threshold uncertainty value; and perform a second training of the neural network based on the shifted data subset.

### FIELD OF THE DISCLOSURE

This disclosure relates generally to machine learning and, more particularly, to methods and apparatus for source-free active adaptation to distributional shifts for machine learning.

### BACKGROUND

Machine learning is a subfield of artificial intelligence. In machine learning, instead of providing explicit instructions, programmers supply data to a model in a process called training. Training allows a machine learning model to infer outputs that were previously unknown to the model.

Training data is supplied to the model to adapt, test, and validate the machine learning model. Training data can be statistically described by its data distribution. A data distribution specifies possible output values for a random variable and the relative frequency with which the output values occur. Machine learning models trained on an underlying distribution may accurately infer output when provided new input data samples from the same underlying distribution.

Machine learning models are often trained and executed with data of different distributions. Furthermore, when a trained machine learning model is deployed, it may be provided data from a continuously shifting data distribution. Accordingly, methods of adapting machine learning models to shifting data distributions is an area of intense industrial and research interest.

### BRIEF DESCRIPTION OF THE DRAWINGS

FIG. 1 is a schematic illustration of an example environment in which a source-free active adaptation circuitry operates to perform source-free active adaptation of a machine learning model.

FIG. 2 is a block diagram of an example implementation of the source-free active adaptation circuitry of FIG. 1.

FIG. 3 is a block diagram illustrating an example flow of data through source-free active adaptation circuitry of FIG. 1.

FIG. 4 is a block diagram of an example implementation of the batch normalization circuitry of FIG. 2.

FIG. 5 is a density histogram corresponding to entropy of samples of data.

FIG. 6 is an illustration of continually evolving distributional shifts in a real-world setting.

FIG. 7 is a set of graphs illustrating accuracy after adapting to corruptions in a continually evolving data set.

FIG. 8 is a set of graphs illustrating improvements to the functioning of computers with the source-free active adaptation circuitry of FIG. 1.

FIG. 9 is a flowchart representative of example machine readable instructions and/or example operations that may be executed by example processor circuitry to implement the source-free active adaptation circuitry of FIG. 2.

FIG. 10 is another flowchart representative of example machine readable instructions and/or example operations that may be executed by example processor circuitry to implement the source-free active adaptation circuitry of FIGS. 1-3.

FIG. 11 is a block diagram of an example processing platform including processor circuitry structured to execute the example machine readable instructions and/or the example operations of FIGS. 9-10 to implement the source-free active adaptation circuitry FIGS. 1-3.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 9-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to real world imperfections as will be understood by persons of ordinary skill in the art. For example, “approximately” and “about” may indicate a tolerance range of +/- 10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/- 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Diverse types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Deep learning is a ML method that is based on learning data representations, as opposed to task-specific procedures. Deep learning models attempt to define a relationship between input data and associated output data. Deep learning is computationally intensive, requiring significant processing capabilities and resources. Deep learning models are often trained on data in a static environment that does not replicate the dynamic nature of real-world data. Due to the differences between a live environment and a controlled training environment, accuracy of the machine learning model may degrade.

Distributional shift refers to a shift in data that is provided to a model over time. Also called covariate shift, distributional shift often occurs when the distribution of input data shifts between the training environment and the deployed environment (e.g., real-world, post-training, production, etc.). Catastrophic interference (e.g., catastrophic forgetting) is a tendency of a neural network to forget previously learned information when the network is trained on new information.

Solutions to reduce catastrophic forgetting often use memory-based approaches and/or experience replay based approaches. Some memory-based approaches store a subset of source data that is used to constrain optimization of a machine learning model. In this way, loss associated with the subset of source data is reduced. Experience replay describes techniques in which a subset of samples from a source data is stored and used for retraining the model. Prior solutions based on memory and/or experience replay use a subset of past data during fine-tuning (e.g., retraining, partial retraining, etc.) of the model. However, saving past samples may negatively affect user privacy.

Examples disclosed herein include uncertainty-based approaches to select a subset of samples of a shifted data set which can be used for fine-tuning of a machine learning model. Some examples disclosed herein include neural network models and techniques for training (e.g., adapting, altering, modifying) the models to continually adapt to evolving data distributions while reducing and/or eliminating catastrophic forgetting.

Disclosed examples enable a machine learning model to detect shifts/drift in a data distribution based on uncertainty-aware techniques. Uncertainty-aware techniques identify a subset of data samples that can be used to fine-tune the machine learning model (e.g., adapt to an evolving distributional shift of underlying data). Therefore, examples disclosed herein provide a computer-implemented technical solution to the problem of continually evolving covariate shift in data. Some examples include a source-free active adaptation method to adjust (e.g., fine-tune, modify, adapt, etc.) a neural network to evolving data (e.g., domain drift or distributional shift) while avoiding catastrophic forgetting.

Pseudo-labeling involves training a model on a batch of labeled data. In pseudo-labeling, a trained model is used to obtain labels for unlabeled data based on model predictions. In examples disclosed herein, source-free active adaptation circuitry can select a subset of a shifted data set, and then pseudo-label the selected subset. Some examples disclosed herein provide the subset of data to a human annotator (e.g., a domain expert) to label the samples.

Examples disclosed herein may improve machine learning efficiency for a variety of fields by making machine learning models robust to shifts in data distribution. With techniques described herein, edge computing platforms may perform, for example, computer vision tasks in adverse weather conditions such as rain, fog, etc.

Disclosed examples are source-free. As described herein, source-free means that some or all of past data (e.g., data of a baseline data set, source data, etc.) is not stored. Source-free machine learning techniques may, for example, enhance data privacy. That is, after a first training with source data (e.g., a baseline data set), a second training (e.g., fine-tuning, adaptation, etc.) may be performed on second data set (e.g., a shifted data set), without access to the first (e.g., source, baseline, etc.) data set. In some examples, the second training (e.g., adaptation, fine-tuning) may be performed in a way that reduces and/or minimizes catastrophic forgetting of the first (e.g., source, baseline, etc.) data set.

Some examples utilize uncertainty estimation techniques. The uncertainty estimation techniques may identify a subset of informative samples for model adaptation (e.g., further training, fine-tuning). This reduces the compute burden of training the models and improves the training of the models. Thus, examples disclosed herein adapt a model to new data distributions (e.g., representative of data drift/shift) while not forgetting (e.g., maintaining performance on) past distributions using uncertainty estimation techniques.

In some examples, a cloud and/or a remote server performs a first training of a model and a subsequent fine-tuning of the model for shifted data. Communicating only the batch-norm statistics and/or all model parameters to the connected devices ensures that the models are up to date. Thus, examples that include edge devices can be updated without having to perform computationally intensive training at the edge device. Furthermore, as such examples are source-free, less storage is used when compared to prior solutions.

In some examples, a model may be trained on a cloud server and the cloud server may transmit the new parameters to the connected devices. Server-side training with transmission of parameters (e.g., batch-norm parameters) to edge devices helps edge devices adapt quickly while pushing computational workloads off the edge devices.

Examples disclosed herein address the technical problems above while enhancing data privacy for model adaptation. Some examples perform a first training of a neural network on a first data set (e.g., a baseline data set, a source data set, etc.) associated with a first data distribution (e.g., a distribution of the baseline data, a distribution of the source data, etc.), and then compare data of a second data set (e.g., a shifted data set) to a threshold uncertainty value. Data that satisfies the threshold uncertainty value is associated with a distributional shift between the first data set and the second (e.g., shifted) data set. By selecting data that satisfies the threshold uncertainty value, a third data set (e.g., a subset of data, a shifted data subset, etc.) can be generated that includes at least one item of the second (e.g., shifted) data set that satisfies the threshold uncertainty value. A second training of the neural network may then be performed on third data set (e.g., the shifted data subset).

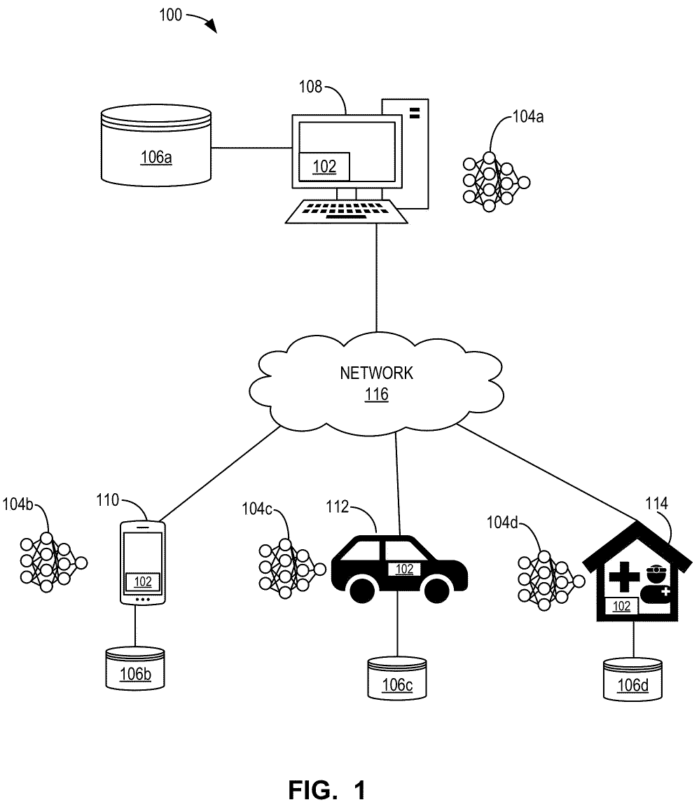

Turning to the figures, FIG. 1 is a schematic illustration of an example environment 100 in which source-free active adaptation circuitry operates to perform source-free active adaptation of a machine learning model. The example environment 100 includes example source-free active adaptation circuitry 102, a first example neural network 104a, a second example neural network 104b, a third example neural network 104c, and a fourth example neural network 104d, example first training data 106a, example second training data 106b (e.g., a shifted data set), example third training data 106c (e.g., a shifted data set), an example first server 108, an example cellular phone 110, an example vehicle 112, an example medical environment 114, and an example network 116.

The neural network 104a is trained at the server 108 with the first training data 106a (e.g., baseline data, source data, etc.). An instance of the trained neural network is then transmitted to the example cellular phone 110, the example vehicle 112, and/or the example medical environment 114 for real-world inference and fine-tuning without use of source data.

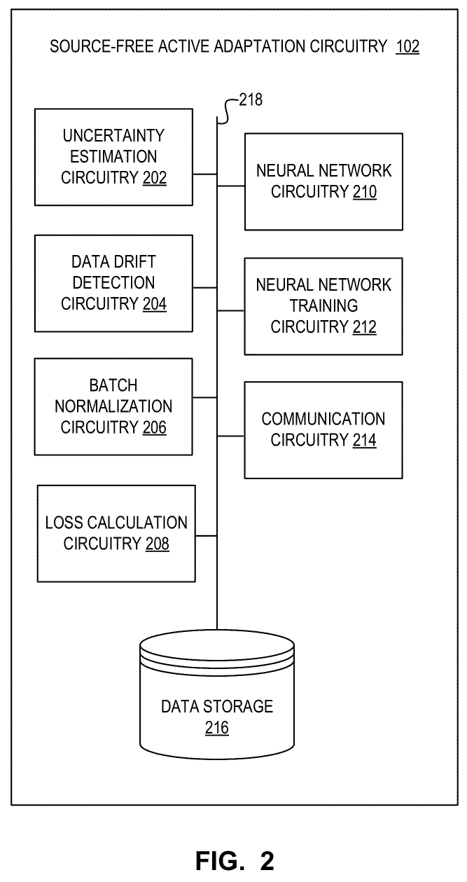

The model 104a is a model that is trained on an initial dataset (e.g., a baseline data set, a source data set) and then deployed on various devices. After deployment, each device is capable of identifying shifted data using uncertainty estimation techniques, such as with the uncertainty estimation circuitry that will be described in association with FIG. 2.

Information including neural network parameter values may be communicated from the environments 110, 112, and 114 to the server 108 via the network 116. At the server, the model 104a can be adapted (e.g., update model parameters) once a new (e.g., shifted) distribution is detected. The updated model parameters can be communicated to the models 104b-104d. Therefore, in some examples, a model may be distributed over a grouping of devices.

In other examples, the machine learning models 104a-d may all be on mobile devices and connected to the server 108. As any of the models 104b-104d may include data of a shifted data distribution, the models 104b-104d can be updated to adjust to the new shifted distribution. Such examples do not require storage of past samples, reducing storage needs of the deploying the model 104.

In the example system 100, only the batch normalization parameters of the models 104b-d are adjusted in finetuning for the shifted data. By only adjusting the batch normalization parameters, the computational workload is reduced when compared to updating the entirety of models 104b-d. Communicating only the updated batch normalization parameters to the models 104b-d ensures the fine-tuning process is performant and requires less compute and storage.

In the illustration of FIG. 1, the cellular phone 110 may perform image classification, portrait mode photography, text prediction, and/or any other neural network based classification on data obtained at the cellular phone 110. The cellular phone 110 may be updated and fine-tuned with the source-free active adaptation circuitry 102 without access to the source (e.g., baseline) data 106a and while reducing and/or eliminating catastrophic forgetting.

The autonomous vehicle 112 may perform image classification, object detection, object trajectory projection, and/or any other neural network based classification on data obtained at the autonomous vehicle 112. The autonomous vehicle 112 may be updated and fine-tuned with the source-free active adaptation circuitry 102 without access to the source data (e.g., baseline data) and while reducing and/or eliminating catastrophic forgetting.

The source-free active adaptation circuitry 102 is also shown in the medical environment 114. The medical environment 114 includes the source-free active adaptation circuitry 102 to perform fine-tuning on a neural networks. Such neural networks may identify diseases, assist in medical imaging, predict patient outcomes, etc.

The examples of the cellular phone 110, the autonomous vehicle 112, and the medical environment 114 are examples of environments in which the source-free active adaptation circuitry 102 may operate. However, source-free active adaptation circuitry 102 may be disposed in any edge device to improve deep learning performance on datasets for which the underlying distribution may shift (e.g., smart homes, internet of things devices, etc.).

The server 108, the cellular phone 110, the autonomous vehicle 112, and/or the medical environment 114 may execute an instance of the source-free active adaptation circuitry 102. The source-free active adaptation circuitry 102 continually adapts to evolving data distributions while reducing and/or eliminating the catastrophic forgetting. The structure and function of the source-free active adaptation circuitry 102 will be described in association with FIG. 2.

The server 108, the cellular phone 110, the autonomous vehicle 112, and the medical environment 114 are connected by the network 116. In some examples, the server 108 may train the neural network 104a on the first dataset 106a (e.g., the baseline dataset 106a, the source dataset 106a), and then transmit the trained neural network 104a to each of the cellular phone 110, the autonomous vehicle 112, and the medical environment 114. Then, at each of the cellular phone 110, the autonomous vehicle 112, and the medical environment 114, a respective instance of the neural network circuitry 102 may be fine-tuned with new datasets (e.g., the shifted dataset 106b, the shifted dataset 106c, etc.).

In the example of FIG. 1, a separate instance of the source-free active adaptation circuitry 102 is included in each of the cellular phone 110, the autonomous vehicle 112, and the medical environment 114. However, in some examples the source-free active adaptation circuitry 102 may not be included in one or more of the cellular phone 110, the autonomous vehicle 112, and the medical environment 114.

FIG. 2 is a block diagram of an example implementation of the source-free active adaptation circuitry of FIG. 1. The source-free active adaptation circuitry 102 of FIG. 2 may be instantiated (e.g., creating an instance of, bring into being for any length of time, materialize, implement, etc.) by processor circuitry such as a central processing unit executing instructions. Additionally or alternatively, the source-free active adaptation circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The source-free active adaptation circuitry 102 includes the uncertainty estimation circuitry 202. The uncertainty estimation circuitry 202 performs one or more uncertainty estimation techniques that identify informative samples of data obtained for training of a machine learning model. In general, there are two types of uncertainty: 1) aleatoric uncertainty (e.g., input uncertainty) that is inherent within the input data samples (e.g., sensor noise or occlusion) and 2) epistemic uncertainty (e.g., model uncertainty). Aleatoric uncertainty cannot be reduced even if more data is provided. Epistemic uncertainty corresponds to inadequate knowledge of a model to explain certain data. The uncertainty estimation circuitry 202 may estimate one or both of aleatoric uncertainty and/or epistemic uncertainty.

The uncertainty estimation circuitry 202 determines an uncertainty estimation based on uncertainty values (e.g., an uncertainty estimate) for elements of a data set. The estimation uncertainty circuitry may provide results of the uncertainty estimation to the data drift detection circuitry 204.

The uncertainty estimation circuitry 202 may calculate uncertainty estimates based on, for example, predictive entropy and/or distance-based uncertainty score in a feature space. For example, the uncertainty estimation circuitry 202 may perform a predictive entropy analysis to quantify the uncertainty in the prediction of the model output according to Equation 1 below:

$$H \left(y \left|x , D\right)\right) = - {\sum }_{k = 1}^{K} p \left(y = {c}_{k} \left|x , w\right)\right) log \left(p \left(y = {c}_{k} \left|x , w\right)\right)\right)$$

In Equation 1 above, D corresponds to data the model has been trained on, K corresponds to the total classes, and p(y = cₖ|x,w) corresponds to output from the neural network (e.g., the classifier) with weights w. The predictive entropy captures a combination of aleatoric and epistemic uncertainty. In general, the greater the entropy value, the more uncertain the model is about what class the data belongs to. In some examples, a subset of data may be ranked based on an uncertainty value, with elements of the subset that have the greatest uncertainty value ranked highest. Then, elements may be selected in descending order to generate a shifted data subset for subsequent fine-tuning of a machine learning model.

A second method that may be used alternatively and/or in addition to predictive entropy is a distance-based uncertainty score in the feature space, which explicitly captures the epistemic uncertainty (e.g., model uncertainty). An uncertainty score may be determined according to Equation 2 below:

$${U}_{d i s s i m} = 1 - \left(\frac{z \left({x}_{t}\right) ⋅ z \left(x\right)}{{\left‖z \left({x}_{t}\right)\right‖}_{2} {\left‖z \left(x\right)\right‖}_{2}}\right)$$

Uncertainty estimation circuitry 202 may perform the operations of Equation 2 to determine an uncertainty score (e.g., U_{dissim}), which measures a dissimilarity of an observed feature vector from the neural network (e.g., the neural network 104b) with respect to a training feature embedding. The uncertainty score measures a distance between features of samples observed after the model has been trained (z(x)). A corresponding training features embedding is (z(xₜ)). In some examples, features may be extracted from a penultimate layer of the machine learning model.

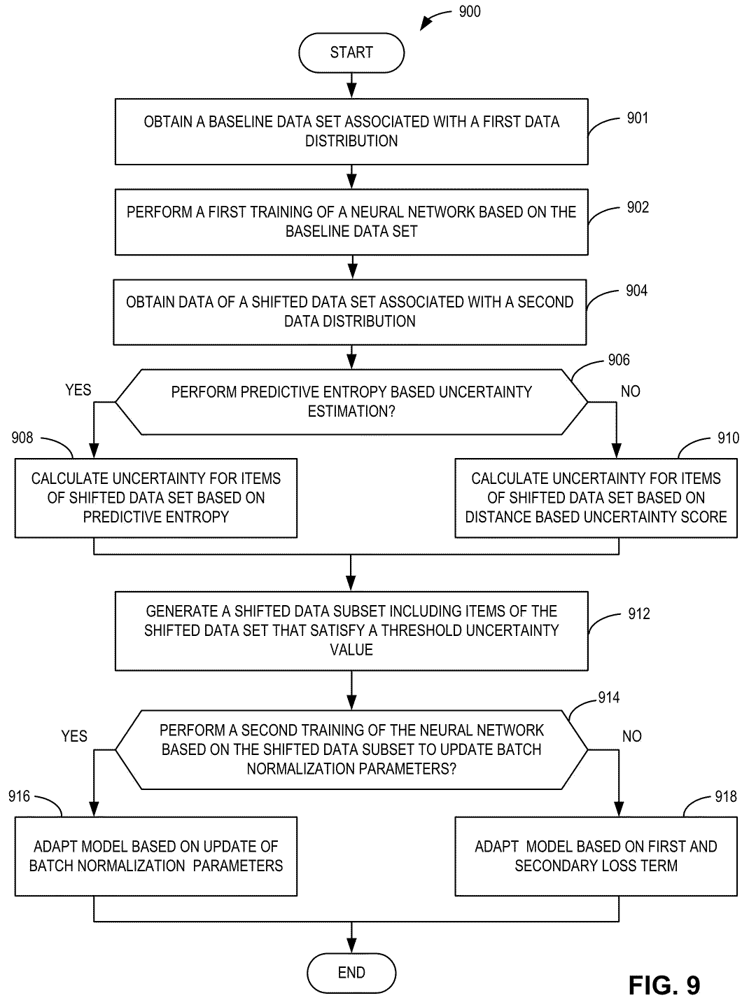

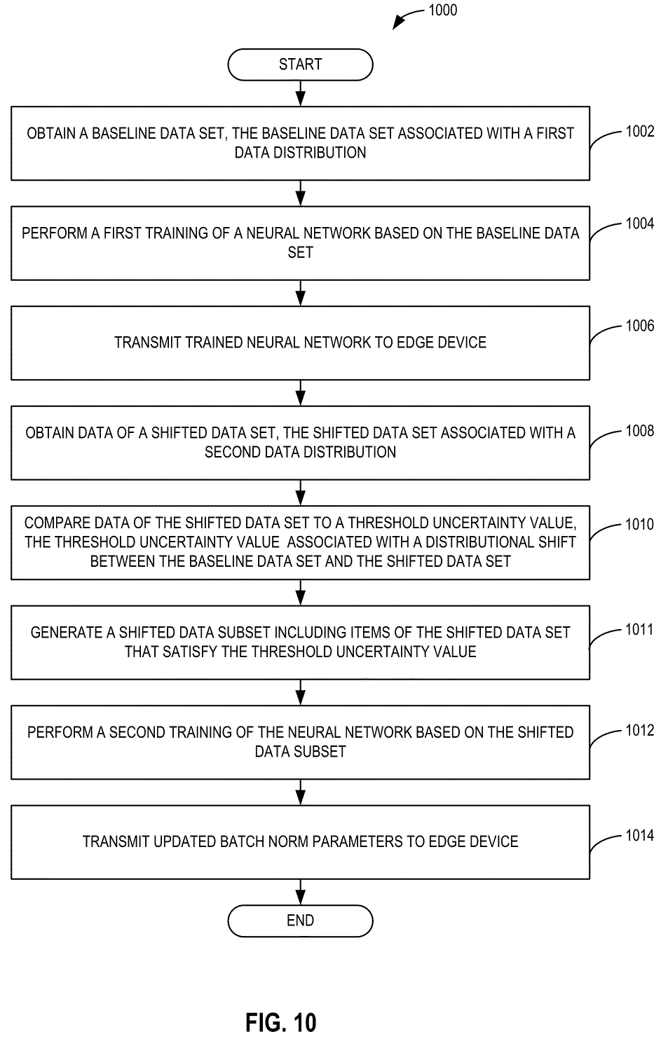

Predictive entropy consists of both the aleatoric and the epistemic uncertainty. The uncertainty estimation circuitry 202 captures the aleatoric and epistemic uncertainty for each input, which helps to detect shifts in the data distribution. Samples far from the learned distribution in feature space will be associated with a high epistemic uncertainty. Therefore, choosing a subset of samples that have high epistemic uncertainty and low aleatoric uncertainty helps to improve the model knowledge. Furthermore, enforcing bi-Lipschitz constraints on the model may improve model sensitivity to changes in input. In some examples, the uncertainty estimation circuitry 202 is instantiated by processor circuitry executing uncertainty estimation instructions and/or configured to perform operations such as those represented by the flowcharts of FIGS. 9-10.

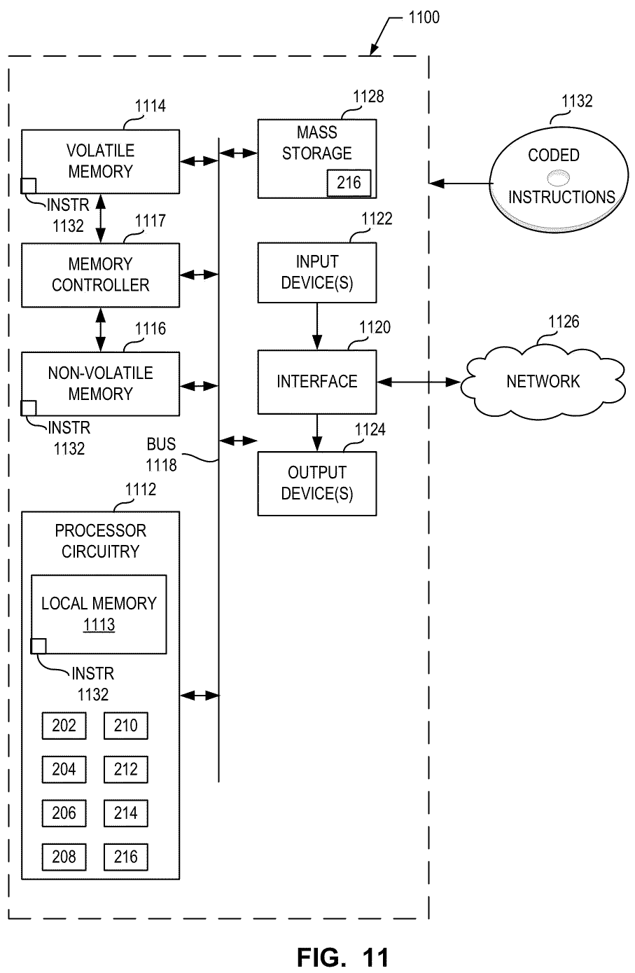

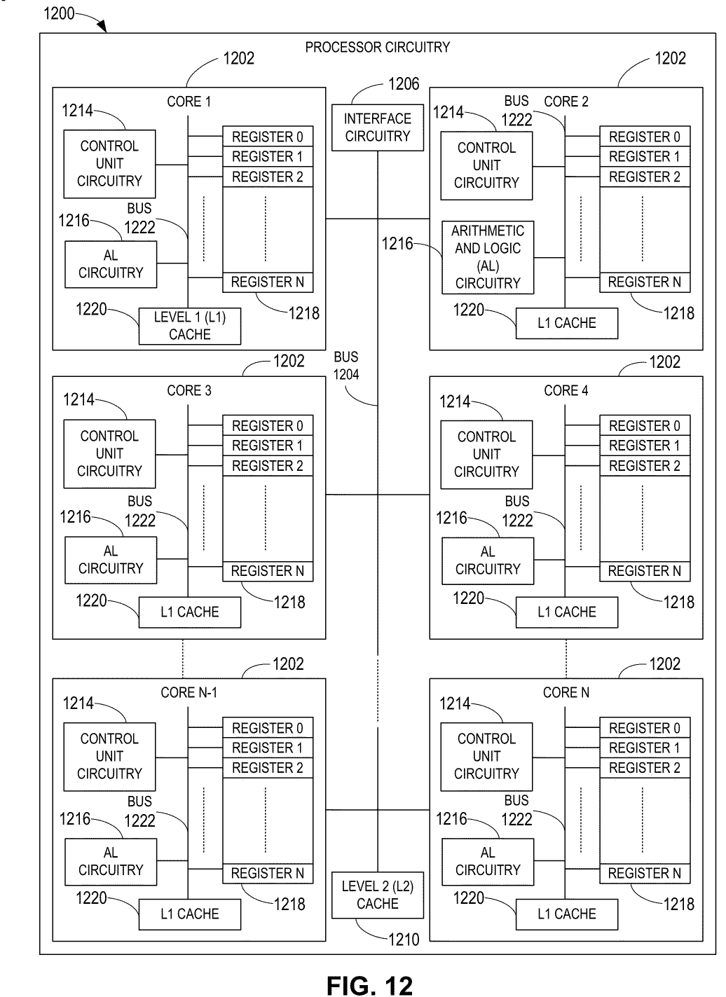

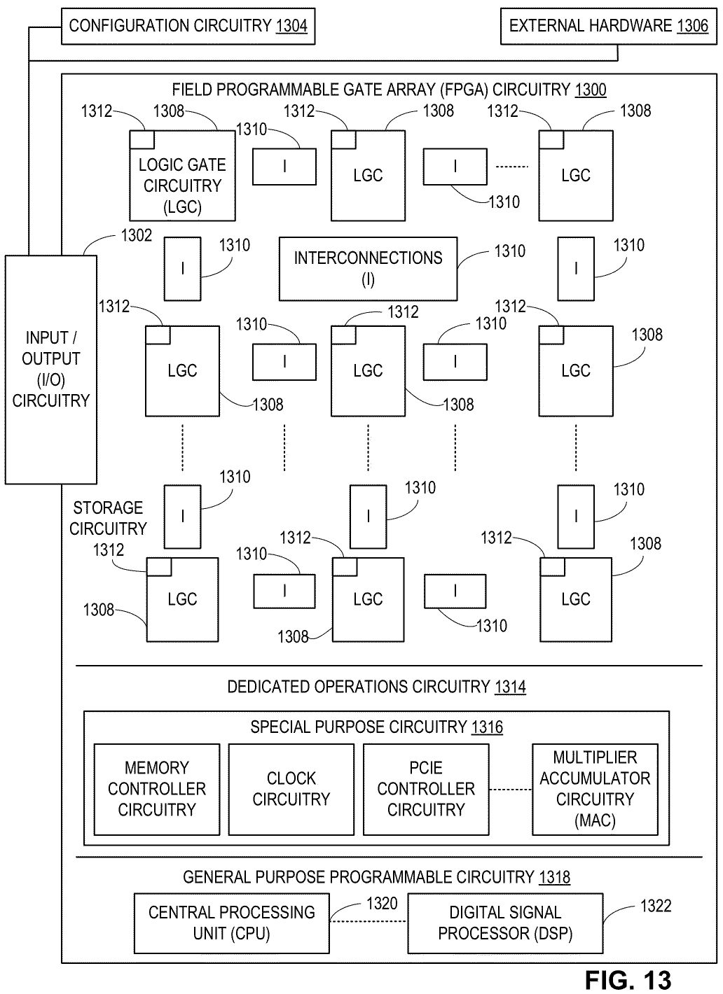

In some examples, the source-free active adaptation circuitry 102 includes means for performing uncertainty estimation. For example, the means for performing uncertainty estimation may be implemented by the uncertainty estimation circuitry 202. In some examples, the uncertainty estimation circuitry 202 may be instantiated by processor circuitry such as the example processor circuitry 1112 of FIG. 11. For instance, the uncertainty estimation circuitry 202 may be instantiated by the example microprocessor 1200 of FIG. 12 executing machine executable instructions such as those implemented by at least blocks 906, 908, 910 of FIG. 9. In some examples, uncertainty estimation circuitry 202 may be instantiated by hardware logic circuitry, which may be implemented by an ASIC, XPU, or the FPGA circuitry 1300 of FIG. 13 structured to perform operations corresponding to the machine readable instructions. Additionally or alternatively, the uncertainty estimation circuitry 202 may be instantiated by any other combination of hardware, software, and/or firmware. For example, the uncertainty estimation circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data drift detection circuitry 204 receives data elements of a production data set (e.g., a shifted data set) and associated uncertainty estimates. The data drift detection circuitry 204 then determines an uncertainty threshold using the dataset. The data drift detection circuitry 204 may determine an uncertainty threshold based on a baseline data set (e.g., source data, in-distribution data, etc.) by calculating uncertainty (e.g., calculating predictive entropy) for elements of the baseline data set (e.g., the training data set). The uncertainty threshold may then be set to a value that is at a tail end of the distribution, such that a significant portion of the baseline data (e.g., 95% of the data) is less than the uncertainty estimate. A tail end of the distribution refers to an area of a distribution (e.g., a normal distribution) that deviates significantly from a mean value of the distribution. For example, the tail end of the distribution may include values that do not lie within three standard deviations of the mean of the distribution.

In some examples, to determine the threshold uncertainty value, the data drift detection circuitry 204 may assign uncertainty values to items of the baseline data set and/or obtain uncertainty values of items of the baseline data set from the uncertainty estimation circuitry 202. The data drift detection circuitry 204 may then set the threshold uncertainty value to be greater than a majority (e.g., approximately 75%, approximately 95%, etc.) of the assigned uncertainty values of the items of the baseline data set.

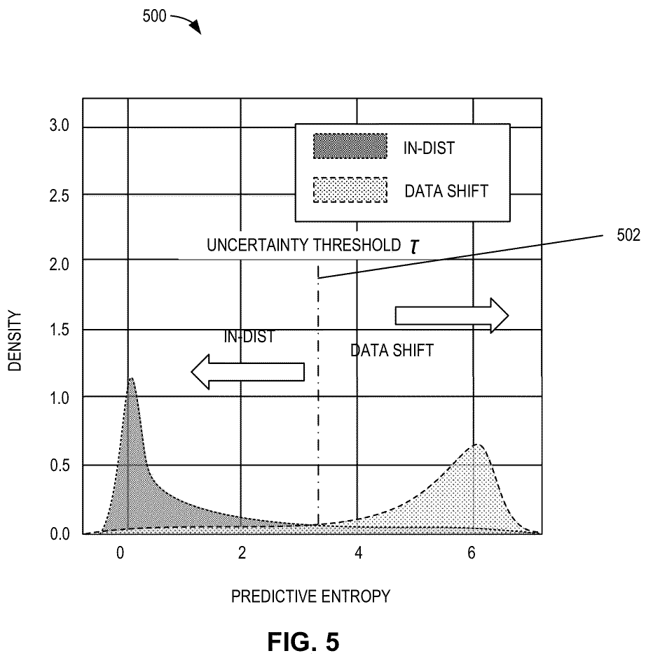

In some examples, the uncertainty threshold corresponds to a predictive entropy value (e.g., a predictive entropy on the histogram of FIG. 5, an x-value on the histogram of FIG. 5) at which an accuracy versus uncertainty metric is near greatest (e.g., an uncertainty threshold 502 of FIG. 5) for in-distribution data. In some examples, for improved generalization, the threshold uncertainty value can be determined based on validation data drawn from the same distribution as the data model was trained.

In some examples, the data drift detection circuitry 204 performs an ordering of samples based on decreasing order of entropy to identify informative samples (e.g., samples with higher uncertainty values) that can be chosen for active labeling. Such a ranking may assist in detecting distributional shift. An example of determination of a distributional shift is shown in the density histogram of FIG. 5.

In some examples, the data drift detection circuitry 204 compares data of a shifted data set to a threshold uncertainty value. The data drift detection circuitry 204 may then generate a shifted data subset including items of the shifted data set that satisfy the threshold uncertainty value. That is, the data drift detection circuitry 204 may obtain items of a data set (e.g., items of a shifted data set) wherein each item has been assigned an uncertainty value (e.g., by the uncertainty estimation circuitry 202). The data drift detection circuitry 204 may then determine if one or more values of the shifted data set satisfy the threshold uncertainty value. In some examples described herein, an item (e.g., an element of the data set, data of the data set, etc.) of a data set (e.g., the shifted data set) satisfies a threshold uncertainty value when an uncertainty value associated with the item is greater than or equal to the threshold uncertainty value. In some examples, the threshold uncertainty value may be satisfied when a difference between an uncertainty value associated with the item and the threshold uncertainty value is less than a threshold difference. In other examples, the threshold uncertainty value may be satisfied when the uncertainty value assigned to the item is within a specified range of the threshold uncertainty value (e.g., within 5% of the threshold uncertainty value).

In some examples, the data drift detection circuitry 204 is instantiated by processor circuitry executing uncertainty estimation instructions and/or configured to perform data drift detection operations such as those represented by the flowcharts of FIGS. 9-10.

In some examples, the source-free active adaptation circuitry 102 includes means for detecting data drift. For example, the means for detecting data drift may be implemented by data drift detection circuitry 204. In some examples, the data drift detection circuitry 204 may be instantiated by processor circuitry such as the example processor circuitry 1112 of FIG. 11. For instance, the data drift detection circuitry 204 may be instantiated by the example microprocessor 1200 of FIG. 12 executing machine executable instructions such as those implemented by at least blocks 912 of FIG. 9. In some examples, data drift detection circuitry 204 may be instantiated by hardware logic circuitry, which may be implemented by an ASIC, XPU, or the FPGA circuitry 1300 of FIG. 13 structured to perform operations corresponding to the machine readable instructions. Additionally or alternatively, the data drift detection circuitry 204 may be instantiated by any other combination of hardware, software, and/or firmware. For example, the data drift detection circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The batch normalization circuitry 206 may take information from the uncertainty estimation circuitry 202 and/or the data drift detection circuitry 204 and update a model (e.g., adapt a model) to data of a distribution that is different that an original data set without catastrophic forgetting.

In some examples, weights of the layers of a neural network are frozen after the initial training (e.g., frozen by the server 108 of FIG. 1). Then, when real-world data (e.g., data shifted from baseline) is provided to the model, only the batch normalization parameters of the model are updated by the batch normalization circuitry 206 to fine-tune the model. In some examples, scale and shift parameters of the batch normalization layer are updated while fine-tuning the model to the shifted data.

In some examples, the batch normalization circuitry 206 is instantiated by processor circuitry executing uncertainty estimation instructions and/or configured to perform data drift detection operations such as those represented by the flowcharts of FIGS. 9-10. In some examples, the batch normalization circuitry 206 includes means for fine-tuning a batch normalization layer of a neural network. For example, the fine-tuning a batch normalization layer of a neural network may be implemented by batch normalization circuitry 206. In some examples, the batch normalization circuitry 206 may be instantiated by processor circuitry such as the example processor circuitry 1112 of FIG. 11. For instance, the data drift detection circuitry 204 may be instantiated by the example microprocessor 1200 of FIG. 12 executing machine executable instructions such as those implemented by at least blocks 914, 916 of FIG. 9. In some examples, batch normalization circuitry 206 may be instantiated by hardware logic circuitry, which may be implemented by an ASIC, XPU, or the FPGA circuitry 1300 of FIG. 13 structured to perform operations corresponding to the machine readable instructions. Additionally or alternatively, the batch normalization circuitry 206 may be instantiated by any other combination of hardware, software, and/or firmware. For example, the batch normalization circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, additionally or alternatively to updating batch normalization parameters, the loss calculation circuitry 208 may ensure that the model does not forget (e.g., catastrophically forget) the past distribution information. The loss calculation circuitry 208 may calculate a first loss term and a second loss term to facilitate fine-tuning the model. In some examples, neural network circuitry 210 and/or the neural network training circuitry 212 are updated by the loss calculation circuitry 208 using the following loss functions of Equations 3-5 below:

$$\begin{matrix}{\text{L = L}}_{1} + \text{β} {\text{L}}_{2} \\ {\text{L}}_{1} = \text{Cross\_entropy\_loss} \left(\text{x}\right) \\ {\text{L}}_{\text{2}} = \text{Cosine\_similarity} \left({\text{z}}_{\text{model\_before\_adaptation}}\right) \\ \left(\left(x\right) , {\text{z}}_{\text{model\_after\_adaptation}} \left(x\right)\right) \\ \text{β=} \text{hyperparameter for relative weighting of} \\ \text{L1 and L2 loss}\end{matrix}$$

$$C o s i n e S i m i l a r i t y = \frac{{z}_{b} \left(x\right) ⋅ {z}_{\text{a}} \left(x\right)}{{\left‖{z}_{b} \left(x\right)\right‖}_{2} ⋅ {\left‖{z}_{a} \left(x\right)\right‖}_{2}}$$

$${D}_{K L} = {\sum }_{x ∈ X} \text{p} \left(x\right) \text{ln} \frac{\text{p} \left(x\right)}{\text{q} \left(x\right)}$$

In Equations 3, z corresponds to features from a penultimate layer of the model. L1 loss improves learning of the model for samples from a new distribution. The L2 loss helps prevent catastrophic forgetting and ensures that the feature embeddings in the model do not deviate too greatly during fine-tuning. In Equation 4, z_{b}(x) corresponds to features obtained from the model before adaptation and zₐ(x) correspond to features obtained from the model after adaptation.

Equation 5 is another method for detecting L₂ loss, based on Kullback-Leibler divergence (e.g., KL divergence) instead of (e.g., or in addition to) cosine similarity. In Equation 5, D_{KL} is KL divergence. p(x) represents features after adaptation and q(x) represents features before adaptation.

In some examples, the loss calculation circuitry 208 is instantiated by processor circuitry executing uncertainty estimation instructions and/or configured to perform loss calculation operations such as those represented by the flowcharts of FIGS. 9-10. In some examples, the source-free active adaptation circuitry 102 includes means for calculating loss (e.g., L1 and L2 loss) of a neural network circuitry 210. For example, the means for calculating loss may be implemented by loss calculation circuitry 208. In some examples, the loss calculation circuitry 208 may be instantiated by processor circuitry such as the example processor circuitry 1112 of FIG. 11. For instance, the loss calculation circuitry 208 may be instantiated by the example microprocessor 1200 of FIG. 12 executing machine executable instructions such as those implemented by at least blocks 918 of FIG. 9. In some examples, loss calculation circuitry 208 may be instantiated by hardware logic circuitry, which may be implemented by an ASIC, XPU, or the FPGA circuitry 1300 of FIG. 13 structured to perform operations corresponding to the machine readable instructions. Additionally or alternatively, the loss calculation circuitry 208 may be instantiated by any other combination of hardware, software, and/or firmware. For example, the loss calculation circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes the example neural network circuitry 210. The neural network circuitry 210 implements a convolutional neural network (e.g., a deep neural network) that may include various convolutional layers, max pooling layers, fixed embedding layers, global averaging layers, etc. In some examples, the example neural network circuitry 210 may include additional and/or alternative machine learning models to predict a class label for a given example input data. For example, the neural network circuitry 210 may interoperate with any other classification algorithm (e.g., logistic regression, naive bayes, k-nearest neighbors, decision tree, support vector machine) to provide improved classification results.

In some examples, neural network circuitry 210 is instantiated by processor circuitry executing neural network and/or configured to perform neural network operations such as those represented by the flowcharts of FIGS. 9-10. In some examples, the neural network circuitry 210 includes means for performing inference with a neural network. For example, the means for performing inference with a neural network may be implemented by the neural network circuitry 210. In some examples, the neural network circuitry 210 may be instantiated by processor circuitry such as the example processor circuitry 1112 of FIG. 11. For instance, neural network circuitry 210 may be instantiated by the example microprocessor 1200 of FIG. 12 executing machine executable instructions such as those implemented by at least blocks 1004 of FIG. 10. In some examples, loss calculation circuitry 208 may be instantiated by hardware logic circuitry, which may be implemented by an ASIC, XPU, or the FPGA circuitry 1300 of FIG. 13 structured to perform operations corresponding to the machine readable instructions. Additionally or alternatively, the loss calculation circuitry 208 may be instantiated by any other combination of hardware, software, and/or firmware. For example, neural network circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example source-free active adaptation circuitry 102 includes neural network training circuitry 212. In some examples, the neural network training circuitry 212 may initialize the neural network circuitry 210 with random weights. The neural network training circuitry 212 may then retrieve training data (e.g., labeled test data) and adjust the weights to produce results consistent with the labeled test data (e.g., minimizing a loss function determined by the loss calculation circuitry 208). The weights of the neural network circuitry 210 are adjusted by the neural network training circuitry 212 based on gradient descent. However, the neural network circuitry 210 may be adjusted based on any other suitable optimization algorithm.

The example neural network training circuitry 212 may retrieve training data from the example data storage 216 and use the retrieved data to train the example neural network circuitry 210. In some examples, the neural network circuitry 210 may perform pre-processing on the training data. In some examples, the neural network circuitry 210 may deduplicate elements of the training set before training.

In some examples, neural network training circuitry 212 is instantiated by processor circuitry executing neural network and/or configured to perform neural network operations such as those represented by the flowcharts of FIGS. 9-10. In some examples, the neural network training circuitry 212 includes means for training a neural network. For example, the means for performing inference with a neural network may be implemented by neural network training circuitry 212. In some examples, neural network training circuitry 212 may be instantiated by processor circuitry such as the example processor circuitry 1112 of FIG. 11. For instance, neural network training circuitry 212 may be instantiated by the example microprocessor 1200 of FIG. 12 executing machine executable instructions such as those implemented by at least blocks 1004, 1012 of FIG. 10. In some examples, neural network training circuitry 212 may be instantiated by hardware logic circuitry, which may be implemented by an ASIC, XPU, or the FPGA circuitry 1300 of FIG. 13 structured to perform operations corresponding to the machine readable instructions. Additionally or alternatively, the neural network training circuitry 212 may be instantiated by any other combination of hardware, software, and/or firmware. For example, neural network training circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes example communication circuitry 214. The example communication circuitry 214 transmits and/or receives information associated with the example source-free active adaptation circuitry 102. For example, a plurality of devices (e.g., the server 108, the cellular phone 110, the vehicle 112, and the medical facility 114 of FIG. 1), each including instances of the communication circuitry 214, may communicate with a server to transmit/receive training data, classification results, a trained model (e.g., the neural network 104a-d), etc. In some examples, the example communication circuitry 214 may transmit a model to a cloud server (e.g., the cloud server 108 of FIG. 1 including an instance of source-free active adaptation circuitry 102).

The example communication circuitry 214 additionally may coordinate communication between the uncertainty estimation circuitry 202, the data drift detection circuitry 204, the batch normalization circuitry 206, the loss calculation circuitry 208, the neural network circuitry 210, the neural network training circuitry 212, and/or a cloud server. Such communication may occur via the bus 218, for example. The source-free active adaptation circuitry 102 further includes a data storage 216 to store any data to facilitate the operations of the source-free active adaptation circuitry 102.

In some examples, communication circuitry 214 is instantiated by processor circuitry executing neural network and/or configured to perform communication operations such as those represented by the flowcharts of FIGS. 9-10. In some examples, the communication circuitry 214 includes means for communication within the source-free active adaptation circuitry 102 and means for communication to entities external to the source-free active adaptation circuitry 102. For example, the means communicating may be implemented by the communication circuitry 214. In some examples, neural network training circuitry 212 may be instantiated by processor circuitry such as the example processor circuitry 1112 of FIG. 11. For instance, the communication circuitry 214 may be instantiated by the example microprocessor 1200 of FIG. 12 executing machine executable instructions such as those implemented by at least blocks 1006, 1014 of FIG. 10. In some examples, the communication circuitry 214 may be instantiated by hardware logic circuitry, which may be implemented by an ASIC, XPU, or the FPGA circuitry 1300 of FIG. 13 structured to perform operations corresponding to the machine readable instructions. Additionally or alternatively, the communication circuitry 214 may be instantiated by any other combination of hardware, software, and/or firmware. For example, communication circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

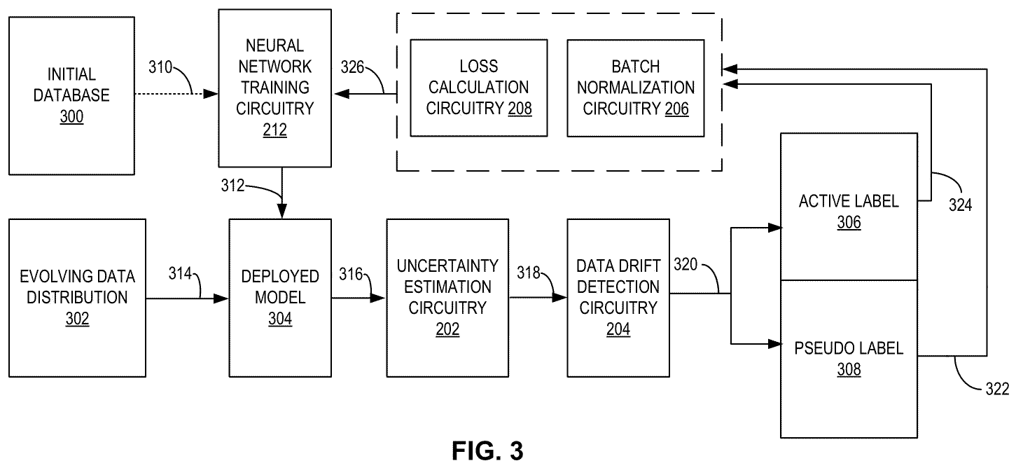

FIG. 3 is a block diagram that shows an example flow of data through an example system for source-free active adaptation to distributional shifts for machine learning. At arrow 310, the example neural network circuitry 210 trains the neural network circuitry 210 of FIG. 2 with data from the initial training database 300 (e.g., the baseline database, the source database).

At arrow 312, the neural network circuitry 210 is deployed as a deployed model 304. Then, at arrow 314, the neural network circuitry 210 obtains samples from an evolving data distribution 302 (e.g., a shifted data distribution). At arrow 316, the uncertainty estimation circuitry 202 of FIG. 2 determines uncertainty associated with samples of data of the evolving (e.g., shifted) data distribution 302. At arrow 318, the data drift detection circuitry 204 selects a subset of the observed samples (e.g., a shifted data subset) based on uncertainty-aware approaches (e.g., Equations 1-2 above) to identify the shifted data. At arrow 320, the example neural network circuitry 210 labels the subset of samples based on either supervised or semi-supervised learning. In the case of supervised learning, the neural network circuitry 210 selects, based on active labeling, labels corresponding to the selected samples. For semi-supervised learning, the shifted subset is pseudo-labeled. At arrows 322 and 324, the batch normalization circuitry 206 and/or the loss calculation circuitry 208 updates the batch norm parameters of the model and/or uses cross-entropy loss (Li) and/or regularization loss (L₂) (e.g., see Equations 3-5 above) to update the model (e.g., at arrow 326). The model is adapted to the subset of data (e.g., the subset of the shifted distribution that includes shifted data values that satisfy a threshold uncertainty value) without the access to the initial database 300 (e.g., source data). That is, after initial training, the initial database 300 data is not used.

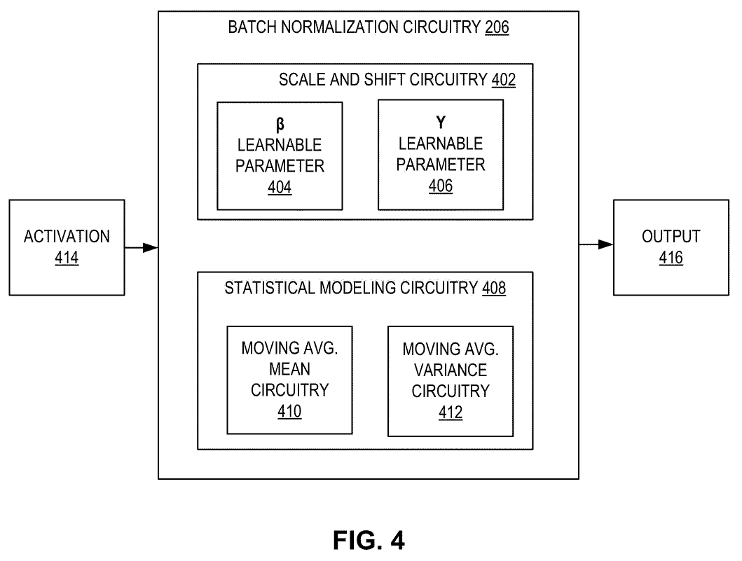

FIG. 4 is a block diagram of an example implementation of the batch normalization circuitry 206 of FIG. 2. The example batch normalization circuitry 206 includes scale and shift circuitry 402. The scale and shift circuitry 402 includes a first learnable parameter 404 (e.g., β, a scale parameter) and a second learnable parameter 406 (e.g., Y, a shift parameter). In some examples the first learnable parameter 404 and/or the second learnable parameter 406 are learned based on training data of a baseline data set. For example, the first learnable parameter 404 and/or the second learnable parameter 406 may be initialized based on a baseline data set that includes images obtained from an autonomous vehicle (e.g., the autonomous vehicle 112 of FIG. 1) on a sunny day. Then, during adaptation (e.g., fine-tuning, a second training, etc.), one or more of the first learnable parameter 404 and/or the second learnable parameter 406 may be updated based on data of a shifted data set (e.g., an image obtained from the autonomous vehicle 112 on a rainy day). Similarly, in a medical environment (e.g., the example medical environment 114 of FIG. 1), the first learnable parameter 404 and/or the second learnable parameter 406 may be learned on a baseline data set (e.g., a first set of x-ray images of an unfractured bone) and then updated based on a shifted data set (e.g., a second set of x-ray images of a fractured bone). The example batch normalization circuitry 206 also includes statistical modeling circuitry 408. The statistical modeling circuitry 408 includes moving average mean circuitry 410 and moving average variance circuitry 412. Parameters in the batch normalization layer are updated while fine-tuning a model to shifted data.

The batch normalization circuitry 206 may obtain an activation 414 (e.g., an input), and then, based on the first learnable parameters 404 and/or the second learnable parameter 406, generate an output 416. For example, the batch normalization circuitry 206 may be a batch normalization layer in a neural network that receives input from a hidden layer of the neural network and generates a normalized output based on the input. In some examples, the output 416 (e.g., a normalized output) may be generated based on Equation 6 below:

$$o u t p u t = \frac{x - E \left[x\right]}{\sqrt{V a r \left[x\right] + ∈}} \left(γ + \text{β}\right)$$

FIG. 5 is a density histogram 500 corresponding to the entropy of samples across a shifting dataset. Predictive entropy is greater in elements of a shifted data subset than it is for in-distribution data. The elements that comprise the shifted data subset may be determined based on an uncertainty threshold 502.

For example, the uncertainty estimation circuitry 202 may determine predictive entropy values for data in a dataset. Then, the data drift detection circuitry 204 may identify in-distribution and out-of-distribution data of the dataset. In some examples, the data drift detection circuitry 204 determines the uncertainty threshold 502 by identifying a threshold value at which an accuracy versus uncertainty metric is greatest on in-distribution data. In some examples, the threshold 502 can be determined based on validation data drawn from the same distribution as the data model was trained for improved generalization.

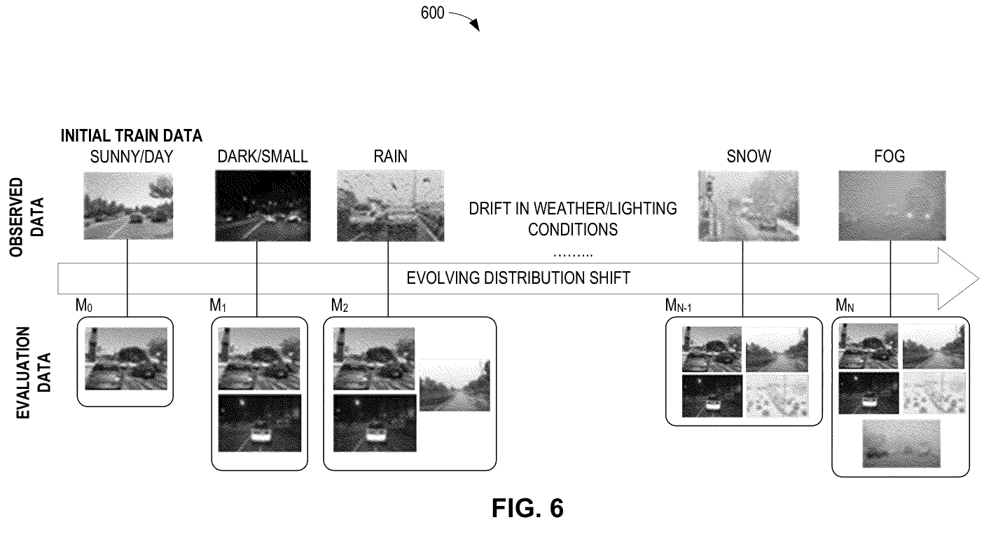

FIG. 6 is an illustration 600 of continually evolving distributional shifts in a machine learning model deployed in the real-world. In the illustration 600, neural network circuitry (e.g., neural network circuitry 210 of the source-free active adaptation circuitry 102) is trained on initial training data (e.g., source data, clean data, baseline data, etc.). The neural network circuitry is then exposed to new data representative of a continually evolving distributional shift. The neural network circuitry subsequently adapts, while not catastrophically forgetting past learning.

Therefore, the illustration 600 is an example of improvements associated with the source-free active adaptation circuitry 102. The source-free active adaptation circuitry 102 allows a machine learning model to improve performance on a newly learned distribution as well as maintain performance on previously learned data distributions. In the illustration 600, initial training data (e.g., sunny day) is used for training. Then, as time passes and weather conditions change, the model adapts to the changing conditions using the techniques described herein. With the source-free active adaptation circuitry 102 of FIG. 2, a model is built that maintains robust performance in the face of continually evolving shifts in the data distribution.

Although the example illustration 600 of FIG. 6 is described in association with an autonomous driving system, the source-free active adaptation circuitry 102 may improve any AI applications in which a data distribution drifts over time (e.g., due to changing environmental settings, weather/lighting conditions, visual concept changes, sensor degradation, etc.).

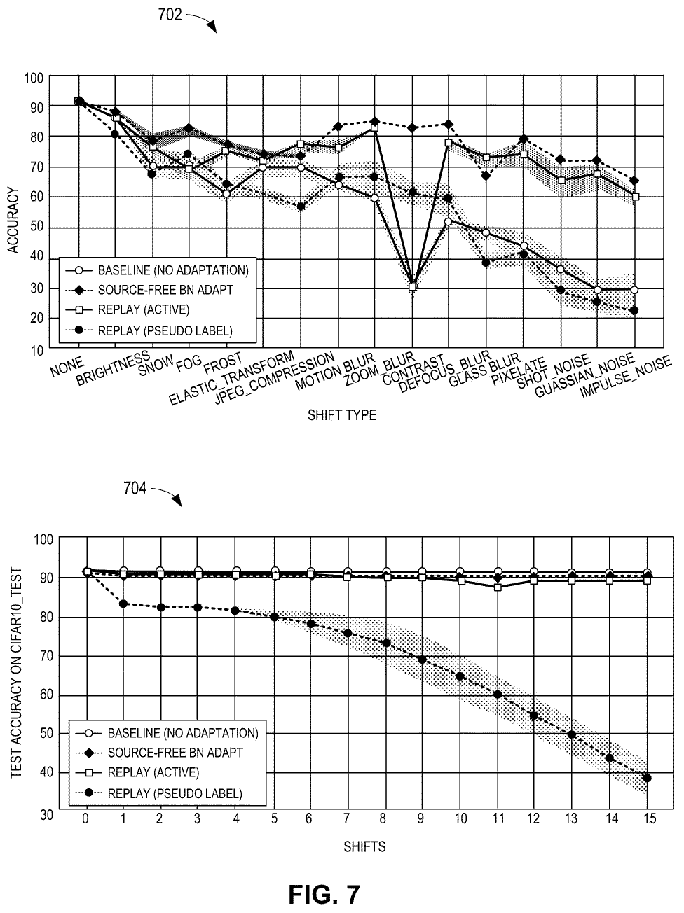

FIG. 7 includes a first graph 702 and a second graph 704 indicative of improvements to computer hardware and the functioning of computer-based systems provided by the source-free active adaptation circuitry 102 of FIG. 2. The first illustration 702 is a comparison of accuracy of source-free active adaptation circuitry 102 of FIG. 2 after adapting to corruptions in a Canadian Institute For Advanced Research (e.g., CIFAR) dataset. An x-axis denotes an order in which corruptions are introduced to the model. In this example, the source-free active adaptation circuitry 102 improved accuracy by 21.3% on average.

The second illustration 704 illustrates accuracy of various methods on a clean CIFAR test data set, after the source-free active adaptation circuitry 102 of FIG. 2 has adapted a model for each corruption. The x-axis corresponds to the number of corruptions the model adapted to. Thus, the source-free active adaptation circuitry 102 of FIG. 1 improves the functioning of a computer, even in the absence of past sample information.

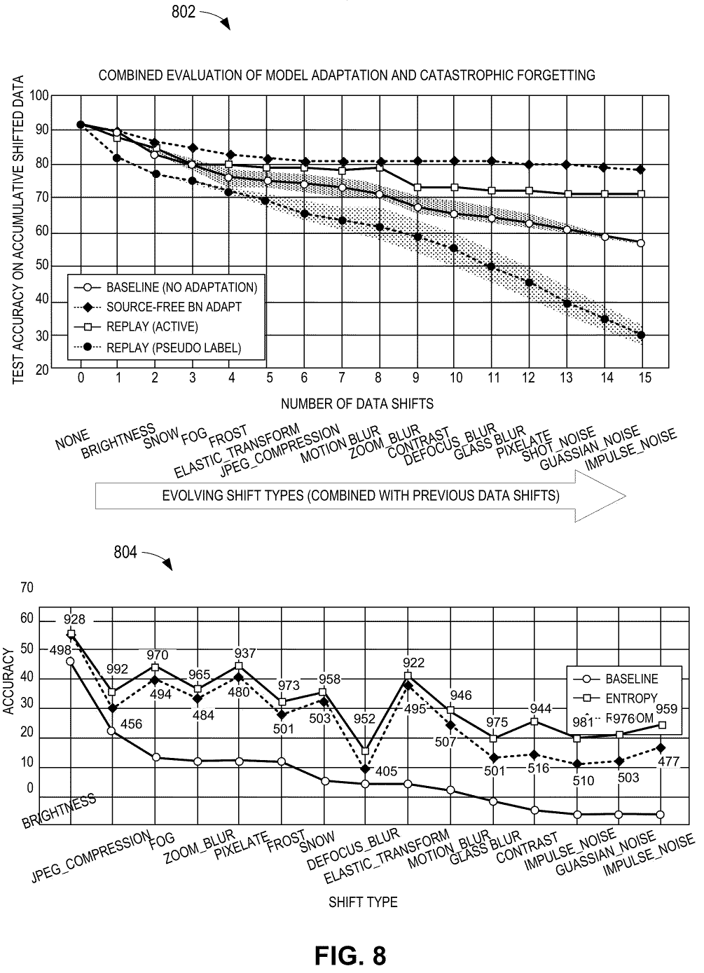

FIG. 8 includes a third graph 802 and a fourth graph 804. The third graph 802 indicates performance on cumulative test data (e.g., a combined evaluation of adaptation and forgetting). The source-free active adaptation circuitry 102 generates models with improved performance on a current distribution shift, while also performing well on previous performance shifts. The third graph 802 indicates that the source-free active adaptation circuitry 102 retains performance even on past information that source-free active adaptation circuitry 102 can no longer access.

The fourth graph 804 presents a comparison of accuracy of the methods after adapting to each corruption in the continually evolving setup for corrupted data. The fourth graph 8004 also indicates the number of samples corresponding to the shifted data (e.g., out of the 1000 samples chosen for updating the model). In the fourth graph 804, the source-free active adaptation circuitry 102 improved accuracy by 24.9% on average from baseline.

While an example manner of implementing the source-free active adaptation circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example uncertainty estimation circuitry 202, the example data drift detection circuitry 204, the example batch normalization circuitry 206, the example loss calculation circuitry 208, the example neural network circuitry 210, the example neural network training circuitry 212, the example communication circuitry 214, and/or, more generally, the example source-free active adaptation circuitry 102 of FIG. 1, may be implemented by hardware alone or by hardware in combination with software and/or firmware. Thus, for example, any of the example uncertainty estimation circuitry 202, the example data drift detection circuitry 204, the example batch normalization circuitry 206, the example loss calculation circuitry 208, the example neural network circuitry 210, the example neural network training circuitry 212, the example communication circuitry 214, and/or, more generally, the example source-free active adaptation circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example source-free active adaptation circuitry 102 of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the source-free active adaptation circuitry 102 of FIG. 2, are shown in FIGS. 9-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIG. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 9-10, many other methods of implementing the example source-free active adaptation circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 9 is a flowchart representative of example machine readable instructions and/or example operations 900 that may be executed and/or instantiated by processor circuitry to perform source-free active adaptation of a machine learning model. The machine readable instructions and/or the operations 900 of FIG. 9 begin at block 901, at which the neural network training circuitry 212 of FIG. 1 obtains a baseline data set associated with a first data distribution. At block 902, the example neural network training circuitry 212 of FIG. 2 performs a first training of a neural network based on the baseline data set. At block 904, the uncertainty estimation circuitry 202 of FIG. 2 and/or the loss calculation circuitry 208 of FIG. 2 obtains data of a shifted data set associated with a second data distribution. At block 906, the uncertainty estimation circuitry 202 of FIG. 2 determines if predictive entropy will be used for uncertainty estimation.

If so (Block 906: YES), then at block 908 the uncertainty estimation circuitry 202 of FIG. 2 calculates uncertainty for items of the shifted data set based on predictive entropy. If not (Block 906: NO), then at block 910 the uncertainty estimation circuitry 202 of FIG. 2 calculates uncertainty for items of the shifted data set based on a distance-based uncertainty score.

At block 912, the data drift detection circuitry 204 of FIG. 2 generates a shifted data subset including items of the shifted data set that satisfy a threshold uncertainty value. At block 914, the batch normalization circuitry 206 of FIG. 2 determines if the source-free active adaptation circuitry 102 will adapt the model based on a batch normalization layer.

If so (Block 914: YES), then at block 916 the batch normalization circuitry 206 of FIG. 2 adapts the model based on an update of batch normalization parameters. Otherwise (Block 914: NO), at block 918 the loss calculation circuitry 208 of FIG. 2 adapts the model based on first and secondary loss terms. The instructions end.

FIG. 10 is a flowchart representative of example machine readable instructions and/or example operations 1000 that may be executed and/or instantiated by processor circuitry to perform source-free active adaptation of a machine learning model.

At block 1002, the neural network training circuitry 212 of FIG. 2 obtains a baseline data set, the baseline data set associated with a first data distribution. At block 1004, the neural network training circuitry 212 of FIG. 2 performs a first training of a neural network based on the baseline data set. At block 1006, the communication circuitry 214 of FIG. 2 transmits the trained neural network to an edge device. At block 1008, the communication circuitry 214 of FIG. 2 obtains data of a shifted data set, the shifted data set associated with a second data distribution.

At block 1010, the uncertainty estimation circuitry 202 of FIG. 2 and/or the data drift detection circuitry 204 of FIG. 2 compares data of the shifted data set to a threshold uncertainty value, the threshold uncertainty value associated with a distributional shift between the baseline data set and the shifted data set.

At block 1011, the example uncertainty estimation circuitry 202 of FIG. 2 and/or the data drift detection circuitry 204 of FIG. 2 generates a shifted data subset including items of the shifted data set that satisfy the threshold uncertainty value. the At block 1012, the batch normalization circuitry 206 of FIG. 2 and/or loss calculation circuitry 208 of FIG. 2 performs a second training of the neural network based on the shifted data subset. At block 1014, the communication circuitry 214 transmits updated batch normalization parameters to the edge device. The instructions end.

FIG. 11 is a block diagram of an example processor platform 1100 structured to execute and/or instantiate the machine readable instructions and/or the operations of FIGS. 9-10 to implement the source-free active adaptation circuitry 102 of FIG. 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the uncertainty estimation circuitry 202, the data drift detection circuitry 204, the batch normalization circuitry 206, the loss calculation circuitry 208, the neural network circuitry 210, the neural network training circuitry 212, the communication circuitry 214, and the data storage circuitry 216.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIGS. 9-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowchart of FIGS. 9-10 to effectively instantiate the circuitry of FIG. 2 and source-free active adaptation circuitry 102 as logic circuits to perform the operations corresponding to those machine readable instructions. In some such examples, the source-free active adaptation circuitry 102 of FIG. 2 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 9-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 9-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 9-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 9-10. As such, the FPGA circuitry 1300 may be structured to effectively instantiate some or all of the machine readable instructions of the flowcharts of FIGS. 9-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 9-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 9-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 9-10 may be executed by one or more of the cores 1202 of FIG. 12, a second portion of the machine readable instructions represented by the flowcharts of FIGS. 9-10 may be executed by the FPGA circuitry 1300 of FIG. 6, and/or a third portion of the machine readable instructions represented by the flowchart of FIGS. 9-10 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

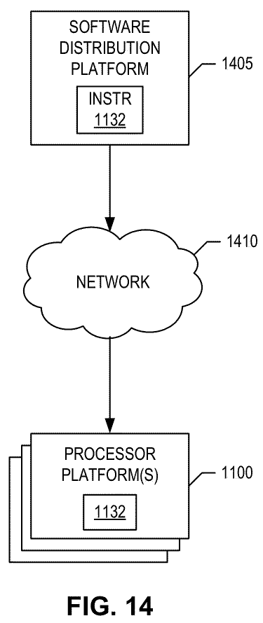

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1432, which may correspond to the example machine readable instructions 900, 1000 of FIGS. 9-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1405. For example, the software, which may correspond to the example machine readable instructions 1132 of FIG. 11, may be downloaded to the example processor platform 1100, which is to execute the machine readable instructions 1132 to implement the source-free active adaptation circuitry 102. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that perform for source-free active adaptation to distributional shifts. Disclosed systems, methods, apparatus, and articles of manufacture improve the efficiency of using a computing device by improve the functioning of a computer by reducing the processing required for a given training workload (e.g., achieving improved training results with fewer data samples). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to perform source-free active adaptation to distributional shifts for machine learning are disclosed herein. Further examples and combinations thereof include the following:

Example 1 includes a system comprising interface circuitry, programmable circuitry, and instructions to cause the programmable circuitry to perform a first training of a neural network based on a baseline data set associated with a first data distribution, compare data of a shifted data set to a threshold uncertainty value, wherein the threshold uncertainty value is associated with a distributional shift between the baseline data set and the shifted data set, generate a shifted data subset including items of the shifted data set that satisfy the threshold uncertainty value, and perform a second training of the neural network based on the shifted data subset.

Example 2 includes the system of example 1, wherein the programmable circuitry is to perform the second training based on a first loss term and based on a second loss term.

Example 3 includes the system of example 1, wherein the programmable circuitry is to update a batch normalization layer of the neural network based on the shifted data subset.

Example 4 includes the system of example 1, wherein to determine the threshold uncertainty value, the programmable circuitry is to assign uncertainty values to items of the baseline data set, and set the threshold uncertainty value to be greater than a majority of the assigned uncertainty values of the items of the baseline data set.

Example 5 includes the system of example 4, wherein the uncertainty values assigned to the items of the baseline data set are predictive entropy values.

Example 6 includes the system of example 2, wherein the first loss term is a cross entropy loss and the second loss term is a cosine similarity of feature embeddings of the neural network before and after model adaptation.

Example 7 includes the system of example 2, wherein the first loss term is a cross entropy loss and the second loss term is a Kullback-Leibler divergence of feature embeddings of the neural network before and after model adaptation.

Example 8 includes the system of example 1, wherein the programmable circuitry is to update at least one of a scale parameter or a shift parameter of a batch normalization layer of the neural network.

Example 9 includes the system of example 1, wherein the threshold uncertainty value is determined based on predictive entropy.

Example 10 includes the system of example 1, wherein samples of the shifted data subset are ranked based on entropy to identify samples for active labeling.

Example 11 includes the system of example 1, wherein the threshold uncertainty value is an epistemic uncertainty value based on feature dissimilarity.

Example 12 includes a non-transitory computer readable medium comprising instructions which, when executed by programmable circuitry, cause the programmable circuitry to perform a first training of a neural network on a baseline data set associated with a first data distribution, compare data of a shifted data set to a threshold uncertainty value, wherein the threshold uncertainty value is associated with a distributional shift between the baseline data set and the shifted data set, generate a shifted data subset including items of the shifted data set that satisfy the threshold uncertainty value, and perform a second training of the neural network based on the shifted data subset.

Example 13 includes the non-transitory computer readable medium of example 12, wherein the instructions, when executed, cause the programmable circuitry to perform the second training based on a first loss term and based on a second loss term.

Example 14 includes the non-transitory computer readable medium of example 13, wherein the instructions, when executed, cause the programmable circuitry to update a batch normalization layer of the neural network based on the shifted data subset.

Example 15 includes the non-transitory computer readable medium of example 13, wherein to determine the threshold uncertainty value, the programmable circuitry is to assign uncertainty values to items of the baseline data set, and set the threshold uncertainty value to be greater than a majority of the assigned uncertainty values of the items of the baseline data set.

Example 16 includes the non-transitory computer readable medium of example 15, wherein the uncertainty values assigned to the items of the baseline data set are predictive entropy values.

Example 17 includes the non-transitory computer readable medium of example 13, wherein the first loss term is a cross entropy loss and the second loss term is a cosine similarity of feature embeddings of the neural network before and after model adaptation .

Example 18 includes the non-transitory computer readable medium of example 13, wherein the first loss term is a cross entropy loss and the second loss term is a Kullback-Leibler divergence of feature embeddings of the neural network before and after model adaptation .

Example 19 includes the non-transitory computer readable medium of example 12, wherein the instructions, when executed, cause the programmable circuitry to update at least one of a scale parameter or a shift parameter of a batch normalization layer of the neural network .

Example 20 includes the non-transitory computer readable medium of example 12, wherein the threshold uncertainty value is determined based on predictive entropy.

Example 21 includes the non-transitory computer readable medium of example 12, wherein samples of the shifted data subset are ranked based on entropy to identify samples for active labeling .

Example 22 includes the non-transitory computer readable medium of example 12, wherein the threshold uncertainty value is an epistemic uncertainty value determined based on feature dissimilarity.

Example 23 includes a method comprising performing, by executing an instruction with processor circuitry, a first training of a neural network on a baseline data set associated with a first data distribution, comparing, by executing an instruction with the processor circuitry, data of a shifted data set to a threshold uncertainty value, wherein the threshold uncertainty value is associated with a distributional shift between the baseline data set and the shifted data set, generating, by executing an instruction with the processor circuitry, a shifted data subset including at least one item of the shifted data set that satisfies the threshold uncertainty value, and performing, by executing an instruction with the processor circuitry, a second training of the neural network based on the shifted data subset.

Example 24 includes the method of example 23, further including performing the second training based on a first loss term and based on a second loss term.

Example 25 includes the method of example 23, further including updating a batch normalization layer of the neural network based on the shifted data subset.

Example 26 includes the method of example 23, further including assigning uncertainty values to items of the baseline data set, and setting the threshold uncertainty value to be greater than a majority of the assigned uncertainty values of the items of the baseline data set.

Example 27 includes the method of example 26, wherein the uncertainty values assigned to the items of the baseline data set are predictive entropy values.

Example 28 includes the method of example 24, wherein the first loss term is a cross entropy loss and the second loss term is a cosine similarity of feature embeddings of the neural network before and after model adaptation.

Example 29 includes the method of example 24, wherein the first loss term is a cross entropy loss and the second loss term is a Kullback-Leibler divergence of feature embeddings of the neural network before and after model adaptation.

Example 30 includes the method of example 23, further including updating at least one of a scale parameter or a shift parameter of a batch normalization layer of the neural network .

Example 31 includes the method of example 23, wherein the threshold uncertainty value is determined based on predictive entropy.

Example 32 includes the method of example 23, wherein samples of the shifted data subset are ranked based on entropy to identify samples for active labeling.

Example 33 includes the method of example 23, wherein the threshold uncertainty value is an epistemic uncertainty value determined based on feature dissimilarity.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A system comprising:
interface circuitry;
programmable circuitry; and
instructions to cause the programmable circuitry to:
perform a first training of a neural network based on a baseline data set associated with a first data distribution;
compare data of a shifted data set to a threshold uncertainty value, wherein the threshold uncertainty value is associated with a distributional shift between the baseline data set and the shifted data set;
generate a shifted data subset including items of the shifted data set that satisfy the threshold uncertainty value; and
perform a second training of the neural network based on the shifted data subset.

2. The system of claim 1, wherein the programmable circuitry is to perform the second training based on a first loss term and based on a second loss term.

3. The system of claim 1, wherein the programmable circuitry is to update a batch normalization layer of the neural network based on the shifted data subset.

4. The system of claim 1, wherein to determine the threshold uncertainty value, the programmable circuitry is to:
assign uncertainty values to items of the baseline data set; and
set the threshold uncertainty value to be greater than a majority of the assigned uncertainty values of the items of the baseline data set.

5. The system of claim 4, wherein the uncertainty values assigned to the items of the baseline data set are predictive entropy values.

6. The system of claim 2, wherein the first loss term is a cross entropy loss and the second loss term is a cosine similarity of feature embeddings of the neural network before and after model adaptation.

7. The system of claim 2, wherein the first loss term is a cross entropy loss and the second loss term is a Kullback-Leibler divergence of feature embeddings of the neural network before and after model adaptation.

8. The system of claim 1, wherein the programmable circuitry is to update at least one of a scale parameter or a shift parameter of a batch normalization layer of the neural network.

9. The system of claim 1, wherein the threshold uncertainty value is determined based on predictive entropy.

10. The system of claim 1, wherein samples of the shifted data subset are ranked based on entropy to identify samples for active labeling.

11. The system of claim 1, wherein the threshold uncertainty value is an epistemic uncertainty value based on feature dissimilarity.

12. A non-transitory computer readable medium comprising instructions which, when executed by programmable circuitry, cause the programmable circuitry to:
perform a first training of a neural network on a baseline data set associated with a first data distribution;
compare data of a shifted data set to a threshold uncertainty value, wherein the threshold uncertainty value is associated with a distributional shift between the baseline data set and the shifted data set;
generate a shifted data subset including items of the shifted data set that satisfy the threshold uncertainty value; and
perform a second training of the neural network based on the shifted data subset.

13. The non-transitory computer readable medium of claim 12, wherein the instructions, when executed, cause the programmable circuitry to perform the second training based on a first loss term and based on a second loss term.

14. The non-transitory computer readable medium of claim 13, wherein the instructions, when executed, cause the programmable circuitry to update a batch normalization layer of the neural network based on the shifted data subset.

15. The non-transitory computer readable medium of claim 13, wherein to determine the threshold uncertainty value, the programmable circuitry is to:
assign uncertainty values to items of the baseline data set; and
set the threshold uncertainty value to be greater than a majority of the assigned uncertainty values of the items of the baseline data set.

16. The non-transitory computer readable medium of claim 15, wherein the uncertainty values assigned to the items of the baseline data set are predictive entropy values.

17. The non-transitory computer readable medium of claim 13, wherein the first loss term is a cross entropy loss and the second loss term is a cosine similarity of feature embeddings of the neural network before and after model adaptation .

18. The non-transitory computer readable medium of claim 13, wherein the first loss term is a cross entropy loss and the second loss term is a Kullback-Leibler divergence of feature embeddings of the neural network before and after model adaptation .

19. The non-transitory computer readable medium of claim 12, wherein the instructions, when executed, cause the programmable circuitry to update at least one of a scale parameter or a shift parameter of a batch normalization layer of the neural network .

20. The non-transitory computer readable medium of claim 12, wherein the threshold uncertainty value is determined based on predictive entropy.

21. The non-transitory computer readable medium of claim 12, wherein samples of the shifted data subset are ranked based on entropy to identify samples for active labeling .

22. The non-transitory computer readable medium of claim 12, wherein the threshold uncertainty value is an epistemic uncertainty value determined based on feature dissimilarity.

23. A method comprising:
performing, by executing an instruction with processor circuitry, a first training of a neural network on a baseline data set associated with a first data distribution;
comparing, by executing an instruction with the processor circuitry, data of a shifted data set to a threshold uncertainty value, wherein the threshold uncertainty value is associated with a distributional shift between the baseline data set and the shifted data set;
generating, by executing an instruction with the processor circuitry, a shifted data subset including at least one item of the shifted data set that satisfies the threshold uncertainty value; and
performing, by executing an instruction with the processor circuitry, a second training of the neural network based on the shifted data subset.

24. The method of claim 23, further including performing the second training based on a first loss term and based on a second loss term.

25. The method of claim 23, further including updating a batch normalization layer of the neural network based on the shifted data subset.

26-33. (canceled)
